(19) United States
(12) Patent Application Publication
(10) Pub. No.: US 2006/0249973 A1
(43) Pub. Date: Nov. 9, 2006

(54) Adjustable display unit in a vehicle

(75) Inventors: Jurgen Dreyer, Schaafheim-Mosbach (DE); Guido Meier-Arendt, Langen (DE); Winfried Moll, Laubach (DE); Horst Welter, Linden (DE)

Correspondence Address: MORRISON & FOERSTER LLP, 1650 TYSONS BOULEVARD, SUITE 300, MCLEAN, VA, 22102, US

(73) Assignee: Siemens Aktiengesellschaft, Munchen (DE)

(21) Appl. No.: 11/373,526

(22) Filed: Mar. 13, 2006

(30) Foreign Application Priority Data
Mar. 14, 2005 (DE) 10 2005 011 634.5

(51) Int. Cl. B62D 25/14

(52) U.S. Cl. 296/70

(57) ABSTRACT

The invention relates to a display unit (1) having a display panel (2) which displays information from an electronic appliance in a vehicle and which is arranged between a first and a second viewer and whose display panel (2) can be oriented either to the first or to the second viewer. In line with the invention, the display unit (1) is provided with a swivel device (4, 12) for automatic orientation. The swivel device (4, 12) is in turn connected to a user identification device which identifies whether the first or the second viewer is currently using the electronic appliance. The swivel device (4, 12) orients the display panel (2) automatically to the viewer identified as the user.

The invention relates to a display unit having a display panel which displays information from an electronic appliance in a vehicle and which is arranged between a first and a second viewer and whose display panel can be oriented either to the first or to the second viewer.

In this context, the term vehicle is understood to mean any means of locomotion which can be used to move at least two people, particularly cars and heavy goods vehicles and also ships.

DE-4213129-A1 discloses a screen, arranged in a front console area of a motor vehicle, in a driver information system in which the screen housing is held so that it can swivel, so that it can be oriented manually to the driver or to the passenger. For the adjustment, a changeover switch fitted in a concealed manner is switched, so that when the screen is oriented to the driver it shows exclusively traffic information and when it is oriented to the passenger it is also permitted to display a TV programme.

It is also known practice to match functions of an electronic appliance in a motor vehicle to the respective user. Thus, DE-19910760-C2 discloses an audio and/or navigation system in which voice recognition or a vehicle key used by the user is used to identify the user and to set system parameters for the audio and/or navigation system on the basis of the user's preferences. DE-4301160-A1 describes a system for user identification in which the driver's seat and the passenger's seat and also at least one control element on an electronic appliance, for example a car telephone, contain electrical coupling elements which close a transmission path for an electrical signal via the person who is in the respective seat when the control element is touched. The electrical signal is supplied to an evaluation circuit, which identifies whether the driver or the passenger has touched the control element. Depending on the current speed of travel, the car telephone is then disabled for the driver, while the passenger may use it at any speed.

It is an object of the present invention to improve a display device of the type mentioned at the outset with regard to its user-friendliness.

This object is achieved by means of an operating device as claimed in claim 1.

In line with the invention, the display unit is provided with a swivel device for automatic orientation. The swivel device, for its part, is connected to a user identification device which identifies whether the first or the second viewer is currently using the electronic appliance. The display panel is then automatically oriented to the viewer identified as the user by the swivel device.

The display unit fitted between the two viewers accordingly no longer needs to be swiveled manually to the respective current user, which significantly simplifies use. Particularly when the two operators change relatively frequently, the disappearance of manual handling will be perceived as a significant simplification.

To avoid adjusting the display unit too frequently and, in particular, unnecessarily, one refinement proposes that the automatic orientation is effected only if a piece of information which is connected to the use of the electronic appliance is output on the display unit for the identified user. It is thus possible to distinguish control operations with and without visual feedback from one another, and adjustment of a display unit is limited to the cases with visual feedback. It may thus be advantageous, for example, if, with a display unit which displays information both from a navigation system and from an audio system, a change in the volume of the audio system by the passenger during a navigation programme which is running for the driver does not result in the display unit being swiveled in the direction of the passenger. This is ensured by virtue of no type of visual feedback about the volume which has been set being output on the display unit.

Provision is also made for the automatic orientation to be effected only for prescribed control operations. For the example mentioned above, this means that swiveling to the passenger is avoided when, although visual feedback about the volume which has been set is output on the display unit, the control operation for setting the volume does not belong to the prescribed control operations for which swiveling is permitted. The prescribed control operations are advantageously control operations which require longer interaction between the user and the electronic appliance, for example starting a navigation operation, selecting a radio station or looking for a telephone number to set up a mobile radio link. The association between these control operations and the control operations for which automatic adjustment of the display unit is permitted is stored in a memory beforehand and is compared with the type of identified control operations during operation.

As a further refinement, it is proposed that besides the automatic orientation it is also possible for the display panel to be oriented manually. The swivel device accordingly makes the coarse setting, while the fine setting is made by the respective viewer. The viewer can orient the display panel to his needs in optimum fashion, depending on seat position and current incidence of light.

This refinement can be developed such that after the first or second viewer has oriented the display panel manually the associated setting values for the swivel device are stored, specifically for the respective viewer, and that the setting values are taken into account for the next automatic orientation.

The viewers accordingly need to make the necessary corrections to the orientation, that is to say the individual adjustment angles, of the display unit or of the display panel only once. For all subsequent swivel operations, the selected orientation is always adopted again precisely. If one of the viewers makes a fresh correction, however, the setting values of this correction are stored as the new orientation which is to be adopted. This means that interaction between the viewer and the display unit is required only if external conditions, such as the seat position, have changed. In all unchanged situations, the display panel is always oriented to the respective viewer in the manner he requires.

In one refinement of the invention, the swivel device contains at least one adjustable-length reciprocating element which is attached to the back of the display unit or of the display panel. In this way, the display unit or the display panel—depending on whether the whole unit or just the display panel is being moved—is pushed away from a fixed base, for example a vehicle console, in the area of the reciprocating element. One or more additionally fitted bearings on sides which are not moved by means of a reciprocating element allow the swivel movement of the display unit or the display panel to be supported.

In one sub-embodiment, two reciprocating elements are attached to the display unit or to the display panel at the same distance symmetrically with respect to an axis of rotation. In this case, one reciprocating element needs to be extended and one reciprocating element needs to be retracted, respectively, in order to swivel the display panel. When the two reciprocating elements are retracted or extended simultaneously, the display panel is in a neutral position.

In a further sub-embodiment, two reciprocating elements are attached to the display unit or to the display panel along a line running parallel to the axis of rotation. This means that both reciprocating elements are simultaneously retracted or extended in order to produce a swivel movement. When the reciprocating elements are extending to different extents, an inclination about an axis running at an oblique angle to the axis of rotation is simultaneously produced.

Combining the two sub-embodiments produces a display panel whose movement can be adjusted in four corners independently of one another. This allows a wide variety of combinations comprising swivel about a vertical axis, serving as an axis of rotation, and inclination about the horizontal axis.

As an alternative to the reciprocating elements, another refinement proposes moving the display unit using a swivel device which contains a ball-and-socket joint which can be adjusted by motor. Such ball-and-socket joints are known from automatically adjustable car mirrors, for example, as described in DE-10209923-A1. Further, the use of “spherical motors” is provided, which are used today as direct drives in the field of robotics and handling technology, for example. Alternatively, it is also possible to use mechanisms with adjustable levers or rack-and-pinion gears.

The invention is explained in more detail below with reference to exemplary embodiments and the drawing, in which

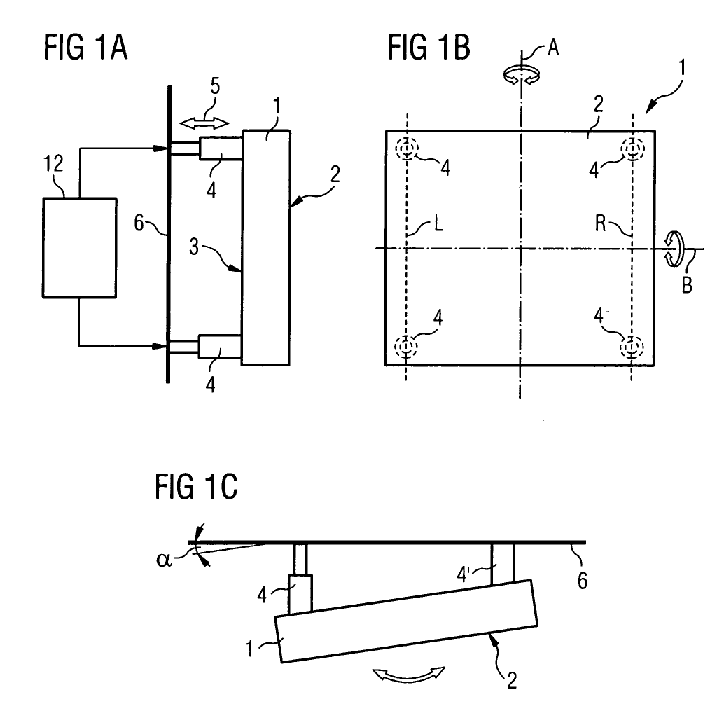

FIGS. 1a-c show a display unit which can be swiveled via for reciprocating elements;

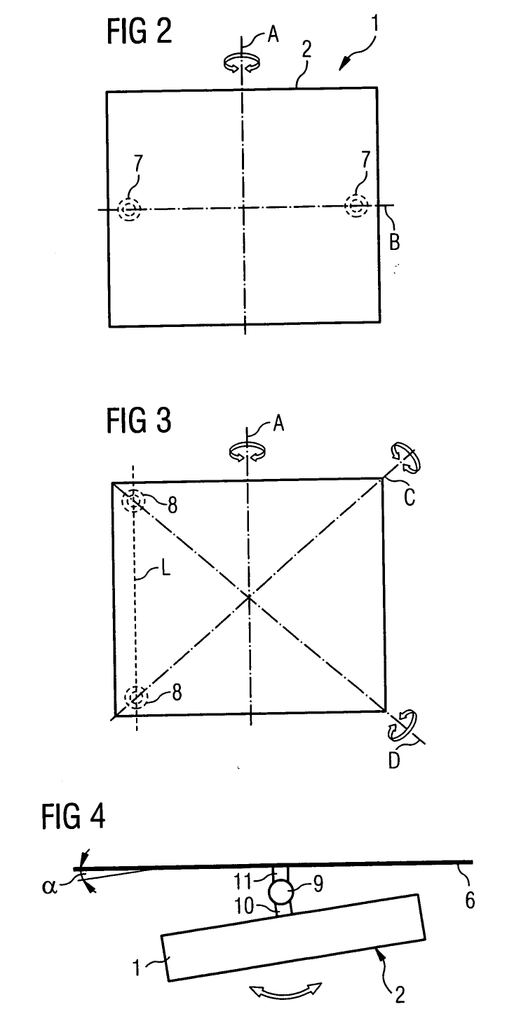

FIG. 2 shows a display unit having two reciprocating elements attached symmetrically with respect to the axis of rotation;

FIG. 3 shows a display unit having two reciprocating elements attached parallel to the axis of rotation;

FIG. 4 shows a display unit with a ball-and-socket joint which can be adjusted by motor.

FIG. 1 shows a display unit 1 having a display panel 2. Attached to the back 3 of the display unit are a total of four reciprocating elements 4, whose longitudinal direction 5 can be automatically adjusted in length, with the adjustment being made by means of a drive device 12 (shown schematically). The display unit 1 is attached to a centre console 6 in a motor vehicle via the reciprocating elements 4, said centre console being situated between a driver's seat arranged to the left of the centre console 6 and a passenger's seat arranged to the right. The display unit 1 is used for graphically outputting various pieces of information from electronic appliances situated in the motor vehicle, for example an air-conditioning system, an audio and video system and a navigation appliance. FIG. 1a shows the arrangement comprising the display unit 1, reciprocating elements 4 and centre console 6 in a lateral view from the direction of the driver's seat. FIG. 1b shows the front view of the display unit 1, which is why the display panel 2 can essentially be seen. The reciprocating elements 4 can be seen in their position relative to the axis of rotation A and also to the transverse axis B of the display panel 2 or the display unit 1. It can clearly be seen that two of the reciprocating elements 4 are respectively arranged on a line L to the left or R to the right of the axis of rotation A, which line runs parallel to the axis of rotation. The reciprocating elements 3 belonging to the left-hand line L are in turn situated symmetrically with respect to the reciprocating elements 3 on the right-hand line R at the same distance from the axis of rotation A.

FIG. 1c shows the view of the display unit 1 from above. The display panel 2 has been swiveled about the angle α in the direction of the passenger, as can be seen in FIG. 1c. To this end, the reciprocating elements 4 belonging to line L, that is to say to the left-hand side, have been extended and the right-hand reciprocating elements 4′ belonging to the line R have been fully retracted. If the driver now presses a key to start the navigation appliance, the driver is identified as the user by means of a user identification device, for example in line with DE-4301160-A1. The starting of the navigation appliance has been defined beforehand as a control operation in which the display unit 1 is intended to be swiveled, which is why the user identification device provides information to the swivel device, i.e. to the drive device 12, that there is intended to be a swivel movement in the direction of the driver. As a result of this information, the drive device 12 prompts the reciprocating elements 4 on the left-hand side to be retracted and the reciprocating elements 4′ on the right-hand side to be extended, so that the display panel 2 is oriented to the driver's side.

FIGS. 2 and 3 show further possible arrangements of reciprocating elements 7 and 8 on the display unit 1. In FIG. 2, two reciprocating elements 7 are arranged symmetrically with respect to the axis of rotation A and on the transverse axis B. Through extension and retraction of these reciprocating elements 7, pure rotation about the axis A is possible. The two reciprocating elements 8 in FIG. 3 are situated on an imaginary line L running parallel to the axis of rotation A. Simultaneously adjusting their length allows pure rotation around A, whereas unequal adjustment of their length allows simultaneous rotation about one of the axes C and D running approximately diagonally across the display panel 2.

In FIG. 4, the display unit 1 is connected to the center console 6 via a ball-and-socket joint 9 and also appropriate connecting elements 10 and 11. In this case too, appropriate actuation of the ball-and-socket joint 9 by motor inclines the display panel 2 about the angle α in the direction of the right-hand passenger's side.

1. A display unit (1) having a display panel (2) which displays information from an electronic appliance in a vehicle and which is arranged between a first and a second viewer and whose display panel (2) can be oriented either to the first or the second viewer, characterized in that the display unit (1) is provided with a swivel device (4, 12) for automatic orientation, in that the swivel device (4, 12) is connected to a user identification device which identifies whether the first or the second viewer is currently using the electronic appliance, and in that the swivel device (4, 12) automatically orients the display panel (2) to the viewer identified as the user.

2. The display unit (1) as claimed in claim 1, wherein the automatic orientation is effected only if a piece of information which is connected to the use of the electronic appliance is output on the display unit (1) for the viewer identified as the user.

3. The display unit (1) as claimed in claim 1, wherein the automatic orientation is effected only for prescribed control operations.

4. The display unit (1) as claimed in claim 1, wherein besides the automatic orientation it is also possible for the display panel (2) to be oriented manually.

5. The display unit (1) as claimed in claim 4, wherein after the first or second viewer has oriented the display panel (2) manually the associated setting values for the swivel device (4, 12) are stored for the viewer and are taken into account for the next automatic orientation.

6. The display unit (1) as claimed in claim 1, wherein the swivel device (4, 12) contains at least one adjustable-length reciprocating element (4) which is attached to the back of the display unit (1) or of the display panel (2).

7. The display unit (1) as claimed in claim 6, wherein two reciprocating elements (4) are attached to the display unit (1) or to the display panel (2) at the same distance symmetrically with respect to an axis of rotation (A).

8. The display unit (1) as claimed in claim 6, wherein two reciprocating elements (4) are attached to the display unit (1) or to the display panel (2) along a line (L, R) running parallel to the axis of rotation (A).

9. The display unit (1) as claimed in claim 1, wherein the swivel device contains a ball-and-socket joint (9) which can be adjusted by motor.
